(19) United States
(12) Patent Application Publication
(10) Pub. No.: US 2019/0113660 A1
(43) Pub. Date: Apr. 18, 2019

(54) PHOTO-EMISSIVE FILM

(71) Applicant: TIAX LLC, Lexington, MA (US)

(72) Inventor: William Barney, Bedford, MA (US)

(21) Appl. No.: 16/161,524

(22) Filed: Oct. 16, 2018

Related U.S. Application Data
(60) Provisional application No. 62/572,829, filed on Oct. 16, 2017.

(51) Int. Cl. G02B 3/04; C09K 11/06; G02B 1/00; G02B 3/00; G01N 21/64

(52) U.S. Cl. CPC G02B 3/04; C09K 11/06; C09K 2211/14; G02B 3/0087; G01N 21/6402; G02B 1/00

(57) ABSTRACT

A photo-emissive film is provided. The photo-emissive film is formed from a luminescent layer that is substantially transparent to at least one excitation wavelength and at least one emission wavelength. The luminescent layer has a first refractive index. A plurality of lenslets is at least partially embedded in the luminescent layer of the photo-emissive film in a substantially single plane. The plurality of lenslets has a second refractive index. The focal point of the plurality of lenslets is external to the plurality of lenslets and within the luminescent layer. The luminescent layer is formed from a polymer, a crystalline material, a glass, or mixtures thereof.

### CROSS REFERENCE TO RELATED APPLICATIONS

This application claims the benefit of U.S. Provisional Application Ser. No. 62/572,829 filed Oct. 16, 2017, the entire contents of which are incorporated herein by reference.

### STATEMENT OF GOVERNMENT INTEREST

This invention was made with U.S. government support under grant FA8650-13C-1599 awarded by the Department of the Air Force and N65236-17-P-1817 awarded by the Department of the Navy. The U.S. government has certain rights in the invention.

### FIELD

The present disclosure relates generally to a photo-emissive film comprising a luminescent layer and a plurality of lenslets that are at least partially embedded in the luminescent layer.

### BACKGROUND

A photo-emissive film is a thin layer or multilayer stack that is excited by radiation in a first wavelength range and, as a consequence, produces emission in a second wavelength range. An emission may be generated by any applicable physical process, including but not limited to fluorescence, phosphorescence, Raman scattering, nonlinear optical processes such as photoionization and harmonic generation, and thermal emission due to sample heating.

As used herein, each reference to flux of radiation is characterized by a wavelength. It will be understood by one skilled in the art that each flux comprises a range of wavelengths, and that the characteristic wavelength is typically a central or average wavelength for that range. The excitation and emission wavelength range is bounded by the lower limit of atmospheric transmission (i.e., about 200 nm) and by the longest wavelength of light that can be focused by a submillimeter spherical lens, which is roughly less than about 500 μm.

If the wavelength of the emission flux is shorter than the wavelength of the excitation flux, the film is called an “upconverting film.” If the wavelength of the emission flux is substantially the same as the excitation flux, the film is called a “resonance-emission film.” If the wavelength of the emission flux is longer than the wavelength of the excitation flux, the photo-emissive film is called a “downconverting film.” Depending on the physical mechanism producing the emission, the film may fall into more than one of these categories. For example, Raman scattering can produce both downconversion (Stokes scattering) and upconversion (anti-Stokes scattering).

Luminescence detection is accomplished by capturing the emission radiation from the film and distinguishing the emission radiation from other concurrently detected radiation, including ambient radiation and reflected excitation radiation.

A luminescent film is actively excited if the observer or detector directs a light source onto the film in order to cause its luminescence. A luminescent film is passively excited if ambient solar or thermal radiation is used as the excitation source.

A cat's-eye optical system is a well-known optical construction, usually used for retroreflection. An example of a typical cat's eye retroreflector 100 is shown in FIG. 1. An excitation wavelength 110 beginning in a first medium 120 enters a second medium 130, where the first medium 120 and the second medium 130 have different refractive indices. For example, the first medium 120 could be air and the second medium 130 could be a transparent plastic. The excitation wavelength 110 then enters a lenslet 140 made of a material with a higher refractive index than second medium 130. The refractive indices of the first medium 120 and the lenslet 140 are chosen so that the excitation wavelength 110 is focused into a focal region 150, which is at a far surface of the lenslet 140.

In typical cat's eye retroreflectors, the lenslet 140 is half-silvered so that it is reflective in the focal region 150. The reflection creates an emission wavelength 160, which undergoes refraction at the interfaces between the lenslet 140, the second medium 130, and the first medium 120 with reverse symmetry, such that the emission wavelength 160 travels antiparallel to the excitation wavelength 110. Note that in FIG. 1, the excitation wavelength 110 and the emission wavelength 160 are drawn for clarity and do not conform to Snell's law. Since the emission wavelength 160 is nearly always antiparallel to the excitation wavelength 110, the optical system according to FIG. 1 functions as a cat's eye retroreflector.

Numerous variations on this scheme are known. For example, the plurality of lenslets 140 may be half-embedded in the second medium 130 so that the excitation wavelength 110 enters directly from the first medium 120 without first passing through second medium 130. In one embodiment, the second medium 130 may be a strongly-scattering medium, for example, a plastic containing titanium dioxide microparticles. A portion of the diffuse reflectance at the far surface of the lenslet 140 is recaptured by the lenslet 140 and is focused back in the direction of the excitation wavelength 110. It is known, for example, to make roadway paints retroreflective by sprinkling glass lenslets on the paint while the paint is wet.

A material with the property of retroreflectivity is useful because a very bright light signal can be detected at the position of the light source. Such a material can be detected at long range or with a weak light source. A material with the property of photo-luminescence is useful because the combination of excitation and emission wavelengths required for detection functions as a “challenge and response” code, guarding against false positive detection caused by reflections or random light emissions. A material that combines both a source-directed emission and photoluminescence would be useful because it can be detected at long range, or with a weak light source, and yet also provide “challenge and response” security to guard against false positive detection. Nevertheless, a material that combines both source-directed emission and photoluminescence has not been produced.

### DESCRIPTION OF RELATED ART

U.S. Pat. No. 8,709,592 to Bird (hereinafter, “Bird”) describes a “retro-reflective” coating, directed specifically to sensing the temperature of a component by luminescence thermometry. Bird describes a base layer containing a luminescent base layer, in combination with a plurality of optical bodies in or on the base layer.

Bird teaches the use of sapphire microspheres with diameters of from 5 μm to 50 μm. However, such microspheres are not easily available. Sapphire microspheres are typically made by grinding/polishing processes or by melting the end of a fiber with a laser. These processes are suited to making single microspheres, whereas a reasonable coating of 50 μm microspheres would require nearly 50,000 microspheres/cm². Glass microspheres are typically made in large quantity by dropping glass powder through a vertical tube furnace, but sapphire has a melting point (e.g., 2030° C. to 2050° C.) beyond the range of most commercial tube furnaces (e.g., less than 2000° C.), and it does not have an amorphous phase, so it may not condense into spheres even if melted.

Moreover, Bird does not describe the deleterious effect of scattering caused by microparticles in the sensor layer. As many of the materials Bird proposes for the sensor layer, specifically phosphors and paints, contain pigment particles that are specifically designed to scatter light, the image formation capability of the optical bodies, on which the system performance depends, will be spoiled if the focal spot is too deep within the sensor layer. As such, only a narrow range of optical body materials can be used with phosphors and paints as the sensor layer. Therefore, the principles taught by Bird cannot be used to design an effective photo-emissive film, such as the one disclosed herein.

U.S. App. No. 2009/0065583 to McGrew discloses a retro-emissive marking system using a cat's-eye optical system. McGrew's application teaches that a retro-emissive lens system that directs fluorescence into an 8° cone will provide a geometric enhancement of 400. We interpret this to be based on a ratio of the radiance of the retro-emissive system compared to the same emissive system without the retro-emissive optics. Without the optics, the emission is emitted into a solid angle of 4π steradians (i.e., a sphere). With the optics, the emission is emitted into 2π(1−cos(8°/2) steradians, or 0.0153 steradians. The ratio of solid angles is 821; McGrew's factor of 400 appears to include a factor of ½, perhaps understanding that half the emission goes in the opposite direction from the lens. However, this calculation assumes that all the light emitted in the direction of the lens will be captured by the lens. The lens in the example has a focal length of 1.5 mm and a width (diameter) of 1 mm. Thus, its acceptance half-angle is roughly 19°, so it subtends a solid angle of 0.35 steradians. As the fluorescence is emitted over 4π steradians prior to entering the lens, only 2.8% of the light will be captured by the lens—not 50% as may have been assumed by McGrew. The geometric enhancement must include both the narrowing of the emission beam and the amount captured by the lens, so the correct value of the geometric enhancement in the example cited by McGrew is closer to 10 rather than 400.

Moreover, McGrew states that in order to obtain a narrow emission angle, it is desirable to have a very thin emission layer. Examples are given of an emission layer of thickness 50 μm and an emission layer of thickness “a few hundred nanometers” (e.g., 500 nm). However, McGrew considers only the use of spherical optics. These have curved focal planes, so that McGrew's FIG. 6 is incorrect as drawn and described: it is impossible to place a planar surface in the focal plane of a spherical lens for an arbitrary entrance angle, because the focal plane is curved. Therefore, if a very thin emission layer, such as one recommended by McGrew, is to be placed in the focal plane of a lens, that focal plane will be optimal only for a small range of entrance angles. McGrew does not teach a solution to this problem.

Overall, the design of a retro-emissive film cannot be clearly determined by the principles enumerated by McGrew, but is rather a complex interplay between lens focal length, refractive indices of the lens and substrate, and the excitation coefficient and concentration of the emissive material. Therefore, while McGrew's application can be used as a general starting point to make a cat's-eye retro-emissive material, its teaching is not sufficient to make a photo-emissive film, such as one described according to embodiments herein.

### SUMMARY

The following summary is provided to facilitate an understanding of some of the innovative features unique to the present invention and is not intended to be a full description. A full appreciation of the various aspects of the invention can be gained by taking the entire specification, claims, drawings, and abstract as a whole.

Provided are photo-emissive films including: a luminescent layer that is substantially transparent to at least one excitation wavelength λ₁ and at least one emission wavelength λ₂, the luminescent layer having a first refractive index n₁, and a plurality of lenslets at least partially embedded in the luminescent layer in a substantially single plane. The plurality of lenslets has a second refractive index n₂, wherein the focal point of the plurality of lenslets is external to the plurality of lenslets and within the luminescent layer; and the luminescent layer comprises a polymer, a crystalline material, a glass, or mixtures thereof.

### BRIEF DESCRIPTION OF THE DRAWINGS

FIG. 1 is an example of a traditional cat's eye retroreflector;

FIG. 2 is a photo-emissive film according to various embodiments as provided in this disclosure;

FIG. 3 is a photo-emissive film according to various embodiments as provided in this disclosure;

FIG. 4 is a lenslet array according to various embodiments as provided in this disclosure at wide (A) and fine (B) magnification;

FIG. 5 illustrates the lenslet array of FIG. 4 with a QD-PMMA film cast over the lenslet array;

FIG. 6 illustrates the temporal decay of quantum dot fluorescence fit to a bi-exponential function;

FIG. 7 illustrates the relationship of target distance and signal intensity for a photo-emissive film according to embodiments as provided in this disclosure illustrating excellent correspondence between model calculations and actual observations;

FIG. 8 illustrates the brightness of a photo-emissive film according to embodiments as provided in this disclosure compared to an ordinary quantum dot-PMMA film without lenslets;

FIG. 9 illustrates an SEM of a cross-section of a photo-emissive film according to embodiments as provided in this disclosure;

FIG. 10 illustrates a light microscope and SEM image of an exposed-design photo-emissive film prepared by an electrostatic deposition—roll press—lamination method as provided in this disclosure;

FIG. 11 illustrates a comparison of an unenhanced film, the photo-emissive film of FIG. 2 according to embodiments, and the photo-emissive film of FIG. 3 according to embodiments; and

FIG. 12(a) illustrates a photo-emissive film, according to various embodiments, wherein the plurality of lenslets has not been subjected to etching;

FIG. 12(b) illustrates a photo-emissive film, according to various embodiments, wherein the plurality of lenslets has been subjected to insufficient etching;

FIG. 12(c) illustrates a photo-emissive film, according to various embodiments, wherein the plurality of lenslets has been completely etched;

FIG. 13 illustrates an optical measurement apparatus designed to measure the emission intensity from a photo-emissive film;

FIG. 14 illustrates a plot of emission intensity as a function of angle obtained from the apparatus of FIG. 13 using a photo-emissive film according to embodiments;

FIG. 15 illustrates an apparatus that can be used to measure the emission intensity from a photo-emissive film according to embodiments; and

FIG. 16 illustrates the results of illuminating the photo-emissive film according to embodiments with the apparatus of FIG. 15.

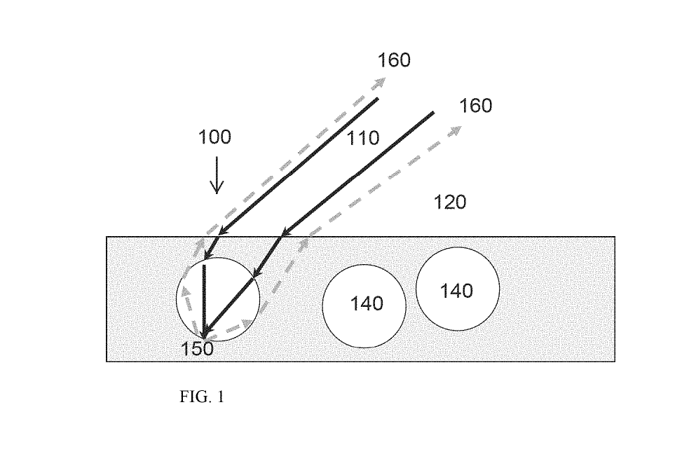

### DETAILED DESCRIPTION

The following description of aspect(s) of the invention is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only.

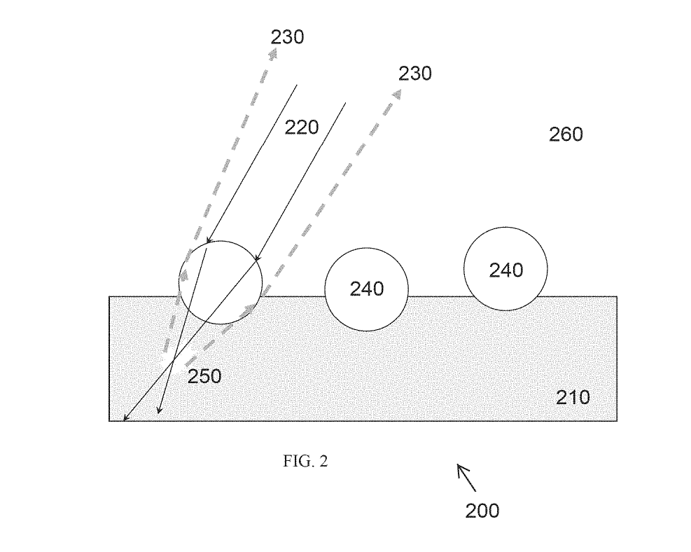

Referring now to FIG. 2, according to embodiments, a photo-emissive film 200 is provided. The photo-emissive film includes a luminescent layer 210 that is substantially transparent to at least one excitation wavelength λ₁ 220 and at least one emission wavelength λ₂ 230. The luminescent layer 210 has a first refractive index n₁, and a plurality of lenslets 240 that are at least partially embedded in the luminescent layer 210 in a substantially single plane. The plurality of lenslets 240 has a second refractive index n₂, wherein the focal point 250 of the plurality of lenslets 240 is external to the plurality of lenslets 240 and within the luminescent layer 210. The luminescent layer 210 comprises a polymer, a crystalline material, a glass, or mixtures thereof.

When illuminated by an excitation beam having an excitation wavelength λ₁ 220, the photo-emissive film 200 produces emission wavelength 2230. This emission wavelength 2230 can be distinguished from the excitation wavelength λ₁ 220, for example, by use of a wavelength selector such as a filter or grating. If the excitation wavelength λ₁ 220 and the emission wavelength λ₂ 230 are substantially identical and cannot be distinguished by a wavelength selector, the excitation wavelength λ₁ 220 and the emission wavelength λ₂ 230 may instead be distinguished by arrival time, as most emission processes are substantially slower than absorption processes.

In some embodiments, the at least one excitation wavelength λ₁ 220 is between about 0.7 μm and 1.7 μm. Optionally, the at least one excitation wavelength λ₁ 220 is between about 0.8 μm and 1.6 μm, between about 0.9 μm and 1.5 μm, between about 1.0 μm and 1.4 μm, between about 1.1 μm and 1.3 μm, or about 1.2 μm. Optionally, the at least one excitation wavelength λ₁ 220 is between about 0.8 μm and 0.85 μm, between about 0.93 μm and 1.07 μm, or between about 1.5 μm and 1.6 μm.

In additional embodiments, the at least one emission wavelength λ₂ 230 is between about 3.6 μm and 4.5 μm. In some embodiments, the at least one emission wavelength λ₂ 230 is between about 3.7 μm and 4.4 μm, between about 3.8 μm and 4.3 μm, between about 3.9 μm and 4.2 μm, between about 3.9 μm and 4.1 μm, or about 4.0 μm.

In certain embodiments, the photo-emissive film 200 emits at least one emission wavelength λ₂ 230 in the direction of a light source. The magnitude of the at least one emission wavelength λ₂ 230 emitted in the direction of the light source is greater than what would be predicted for isotropic emission over 4π steradians.

Referring still to FIG. 2, in embodiments, the photo-emissive film 200 has a total thickness of at least 1.5 times the average focal length of the plurality of lenslets. In some embodiments the thickness is at least 0.01 mm or at least 0.3 mm. Optionally, the thickness of the film is between about 0.01 mm and 3.0 mm.

In further embodiments, the photo-emissive film 200 has a total thickness of between about 0.01 mm and 3.0 mm. In some embodiments, the photo-emissive film 200 has a total width of between about 0.1 mm and 2.9 mm, between about 0.2 mm and 2.8 mm, between about 0.3 mm and 2.7 mm, between about 0.4 mm and 2.6 mm, between about 0.5 mm and 2.5 mm, between about 0.6 mm and 2.4 mm, between about 0.7 mm and 2.3 mm, between about 0.8 mm and 2.2 mm, between about 0.9 mm and 2.1 mm, between about 1.0 mm and 2.0 mm, between about 1.1 mm and 1.9 mm, between about 1.2 mm and 1.8 mm, between about 1.3 mm and 1.7 mm, between about 1.4 mm and 1.6 mm, or about 1.5 mm.

In further embodiments, the plurality of lenslets 240 has an average focal length between about 15 μm and 2,000 μm. In some embodiments, the plurality of lenslets 240 has an average focal length between about 50 μm and 1,900 μm, between about 100 μm and 1,800 μm, between about 200 μm and 1,700 μm, between about 300 μm and 1,600 μm, between about 400 μm and 1,500 μm, between about 500 μm and 1,400 μm, between about 600 μm and 1,300 μm, between about 700 μm and 1,200 μm, between about 800 μm and 1,100 μm, between about 900 μm and 1,100 μm, or about 1,000 μm.

According to these embodiments in which the plurality of lenslets 240 has an average focal length between about 15 μm and 2,000 μm, the luminescent layer 210 has a thickness that is at least about 1.0 times the average focal length of the plurality of lenslets 240. In embodiments, the luminescent layer 210 has a thickness that is at least about 1.5, about 2.0, about 2.5, about 3.0, about 3.5, about 4.0, about 4.5, or about 5.0 times the average focal length of the plurality of lenslets 240. In certain embodiments, the luminescent layer 210 has a thickness that is between about 1.5 times and 5.0 times, between about 2.0 times and 4.5 times, between about 2.5 times and 4.0 times, or between about 3.0 times and 3.5 times the average focal length of the plurality of lenslets 240.

In certain embodiments, the photo-emissive film 200 further includes a photo-emissive additive. The photo-emissive additive assists the photo-emissive film 200 in absorbing the at least one excitation wavelength λ₁ 220 and emitting the at least one emission wavelength λ₂ 230. The photo-emissive additive may include quantum dots, fluorescent dyes, phosphors, or combinations thereof. The photo-emissive additive may assist the photo-emissive film 200 in absorbing the at least one excitation wavelength λ₁ 220 and emitting the at least one emission wavelength λ₂ 230. Quantum dots are suitable as a photo-emissive additive because they can be excited over a range of wavelengths, up to a characteristic wavelength called the exciton wavelength, and emit at a wavelength slightly longer than the exciton wavelength. Quantum dots are especially suitable as a photo-emissive additive when the excitation wavelength λ₁ 220 and the emission wavelength λ₂ 230 differ by a large amount, such as by more than 50 nm.

Additional embodiments of the photo-emissive additive may include an absorbing material that emits infrared radiation by a thermal emission process. One such suitable photo-emissive additive is carbon black. Carbon black may facilitate a thermal infrared emission by absorptively heating the photo-emissive film 200.

In some embodiments of the photo-emissive film 200, the plurality of lenslets 240 may be formed from glass, crystalline materials, polymeric materials, or combinations thereof. Examples of suitable glasses, such as ZBLAN (ZrF₄—BaF₂—LaF₃—AlF₃—NaF) glass. Additional suitable glasses may include sulfide glasses, such as gallium-lanthanum-sulfide glass. Additional suitable glasses may include sulfide glasses, such as gallium-lanthanum-sulfide glass. Examples of suitable crystalline materials include silicon, germanium, calcium fluoride, barium fluoride, potassium bromide, sodium chloride, zinc sulfide, sapphire, and other crystalline materials well known to those skilled in the art. Examples of suitable polymeric materials may include poly(methyl methacrylate) or various fluoropolymers. In certain embodiments, the fluoropolymer is substantially free from a functional amount of C—H, O—H, N—H, or S—H bonds. It is noted that in some embodiments, the luminescent layer 210 may also be formed from any of the glasses, crystalline materials, polymeric materials, or combinations thereof as described hereinabove. In certain embodiments, the luminescent layer 210 may be formed from the same materials as the plurality of lenslets 240. In other embodiments, the luminescent layer 210 may be formed from different materials as the plurality of lenslets 240.

In additional embodiments, the plurality of lenslets 240 has a transmission fraction t₁ at the at least one excitation wavelength λ₁ and a transmission fraction t₂ at the at least one emission wavelength λ₂, where t1 and t2 are each between 0 and 1. The product of t₁t₂ may be at least about 0.3, at least about 0.5, or at least about 0.9.

In some embodiments, the product of t₁t₂ is between about 0.3 and 3.0, between about 0.5 and 2.8, between about 0.7 and 2.6, between about 0.9 and 2.4, between about 1.1 and 2.2, between about 1.3 and 2.0, between about 1.5 and 1.8, or about 1.7.

In embodiments, lenslets forming the plurality of lenslets 240 are substantially spherical and are embedded in the luminescent layer 210 of the photo-emissive film 200 at a depth of between about 40% and 95% of the average diameter of the plurality of lenslets. In these embodiments, a non-embedded portion of the plurality of lenslets is exposed to an ambient medium 260 with refractive index n₁ of about 1 and the plurality of lenslets 240 has a refractive index n₂ of between about 1.3 and 2. The ambient medium, according to embodiments, may be air. As shown in FIG. 2, the degree of exposure of plurality of lenslets 240 to the ambient medium 260 may vary from lenslet to lenslet. However, in certain embodiments, the plurality of lenslets 240 is embedded in the luminescent layer 210 at substantially the same depth.

In some embodiments, the lenslets forming the plurality of lenslets 240 are substantially spherical and are embedded in the luminescent layer at a depth of greater than about 95% of the average diameter of the plurality of lenslets. In these embodiments, the plurality of lenslets 240 has a refractive index n₂ and the luminescent layer 210 has a refractive index n₃, such that the ratio of n₂ to n₃ is between about 1.3 and 2. In certain embodiments, the plurality of lenslets 240 has a refractive index n₂ of about 1.5.

Referring still to FIG. 2, in some embodiments, lenslets forming the plurality of lenslets 240 are aspheric. In these embodiments, the plurality of lenslets 240 may be disposed with a common orientation so that the optical axis of the plurality of lenslets 240 is substantially perpendicular to a face of the photo-emissive film 200.

In any of the above described embodiments, the plurality of lenslets 240 may be arranged in the form of a monolithic film. Such an embodiment of the photo-emissive film 200 may decrease, or eliminate, unnecessary internal scattering of the at least one excitation wavelength λ₁ 220 and/or the at least one emission wavelength λ₂ 230. Further, a monolithic film may reduce or eliminate voids in luminophore distribution, both of which reduce photo-emissive performance of the photo-emissive film 200.

Optionally, the plurality of lenslets 240 has an areal fill factor of greater than about 0.5, greater than about 0.8, or greater than about 0.9. Optionally, the plurality of lenslets 240 has an areal fill factor of between about 0.91 and 1.0.

Optionally, the plurality of lenslets 240 has an average subtended half-angle greater than about 25°, greater than about 30°, or greater than about 35°. In some embodiments, the plurality of lenslets 240 has an average subtended half-angle of between about 20° and 50°, between about 25° and 45°, between about 30° and 45°, between about 30° and 40°, or about 40°.

In certain embodiments, the photo-emissive film 200 further comprises a coating selected from a protective film, a printed film, an optical filter layer, a structural layer, an attachment layer, and combinations thereof. A protective film, printed film, and optical filter layer may consist of any optically clear material including glass, crystalline materials, polymeric materials, or combinations thereof. A printed film comprises an optically clear material and a printed design using inks or pigments that transmit the at least one excitation wavelength λ₁ and the at least one emission wavelength λ₂. In some embodiments the printed design may be decorative or may be for a function such as camouflage. An optical filter layer comprises an optically clear material that absorbs at least one wavelength λ₃ other than the at least one excitation wavelength λ₁ and the at least one emission wavelength λ₂. In some embodiments the optical filter layer may serve to reduce the range of wavelengths that can produce an emission. In some embodiments the protective film, printed film, and optical filter layer are separated from the plurality of lenslets by a plurality of spacers that maintain an air gap so that the plurality of lenslets are in contact with air.

A structural layer comprises any material that provides structural integrity to the photo-emissive film. In some embodiments the structural layer is on the illuminated side of the film and must be optically clear. In some embodiments the structural layer is on the non-illuminated side of the film and may be of any material with structural strength.

An attachment layer is any layer that allows the photo-emissive film to be attached to another object. In some embodiments the attachment layer is an adhesive. In some embodiments the attachment layer is a pressure sensitive adhesive. In some embodiments the attachment layer is a hook and loop fastener system. In some embodiments the attachment layer is magnetic.

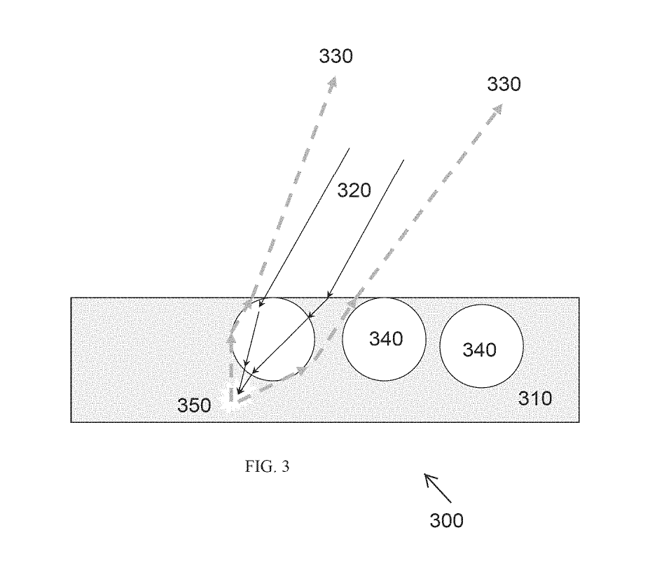

Referring now to FIG. 3, according to embodiments, a photo-emissive film 300 is provided. The photo-emissive film includes a luminescent layer 310 that is substantially transparent to at least one excitation wavelength λ₁ 320 and at least one emission wavelength λ₂ 330. The luminescent layer 310 has a first refractive index n₁, and a plurality of lenslets 340 that are completely embedded in the luminescent layer 310 in a substantially single plane. The plurality of lenslets 340 has a second refractive index n₂, wherein the focal point 350 of the plurality of lenslets 340 is external to the plurality of lenslets 340 and within the luminescent layer 310. The luminescent layer 310 comprises a polymer, a crystalline material, a glass, or mixtures thereof. The photo-emissive film of FIG. 3 may further comprise any of the previously described embodiments pertaining to FIG. 2.

Various aspects of the provided device are illustrated by the following non-limiting examples. The examples are for illustrative purposes and are not a limitation on any practice of the present invention. It will be understood that variations and modifications can be made without departing from the spirit and scope of the invention. Materials and reagents as used herein are commercially available unless otherwise indicated, and a person of ordinary skill in the art readily understands where such reagents may be obtained.

### Example 1

### Downconverting Cooperative Combat ID (CCID) Photo-Emissive Film for Identification of Friendly Forces in Close Air Support

A photo-emissive film is a first object or material that can be affixed to, or blended with, a second object or material for the purpose of identifying, tracking, or locating the second object or material. When excited by an excitation wavelength λ₁, the photo-emissive film produces an emission wavelength λ₂, which is an emission flux of radiation.

A photo-emissive film COD for Close Air Support applications can be designed to be used with laser/detector systems commonly used in military aircraft or in air-launched munition guidance, which are equipped with 1.06 μm combat mode and 1.57 μm eye-safe lasers, and with InSb cameras sensitive in the medium wavelength infrared (MWIR) 3.5 μm to 5 μm spectral region. Therefore, the photo-emissive film must be capable of significant downconversion of the excitation radiation.

Because of the high speed and high altitude of the aircraft and long range of the weapons systems in use, the photo-emissive film must be detectable at very long range (>8 km) to prevent launch if friendly forces are identified.

To achieve high contrast in the MWIR at very long range, in the presence of thermal clutter, such as flares, fires, solar glint, or hot engines it is advantageous to use schemes such as background subtraction or lock-in detection in which the laser and camera are synchronized, and the signal is detected at the laser pulse modulation frequency. Furthermore, the camera integration time is kept short in order to reject slowly varying MWIR sources. Laser pulse widths are on the order of nanoseconds, and it is most desirable to use the emission wavelength λ₂ lifetimes on the order of nanoseconds, or microseconds, to maintain a high brightness relative to slowly varying MWIR sources.

Possible additives to the photo-emissive film include quantum dots, fluorescent dyes, phosphors, absorbing materials, or combinations thereof. Of these, fluorescent dyes are not currently known to emit in the 3.5 μm to 5 μm spectral region, although if such dyes were developed in the future, and could provide the necessary wavelength downconversion, they could be used.

Raman is generally a very weak process, although specialized surface-enhanced Raman-based additives have been developed, for example by Oxonica Ltd., which have much higher efficiency, possibly comparable to fluorescence. Raman scattering can shift the excitation wavelength by typically not more than 3600 cm⁻¹, so a Raman-based photo-emissive film excited at 1.57 μm could produce an emission as far out as 3.61 μm; however, the same photo-emissive film excited at 1.06 μm would only respond at 1.71 μm, whereas an ideal CAS CCID photo-emissive film would give a detectable response to both excitation lasers. Furthermore, Raman scattering efficiency drops off as the fourth power of the excitation wavelength, so that a Raman photo-emissive film excited at 1.57 μm produces a signal 75 times weaker than the more typical 0.53 μm excitation. Finally, SERS photo-emissive films employ nanostructures that localize surface plasmons, and the localized surface plasmon must absorb light at the laser excitation frequency. SERS nanostructures optimized for 1.06 μm and 1.57 μm are under development but are not commercially available at this time. Therefore, Raman based emitters do not appear to be a viable emitter material for this embodiment.

Some phosphors are known which absorb at 1.06 μm or 1.57 μm, and emit at MWIR wavelengths, including praseodymium and dysprosium based phosphors. These phosphors must be incorporated into a specialized matrix, such as gallium lanthanum sulfate glass, which has no phonon energy modes high enough to quench the low energy levels from which the MWIR emission occurs. The absorption bands of these phosphors are very narrow, so the matrix must be carefully engineered to shift the absorption band for good overlap with the laser emission wavelength, or a co-dopant scheme must be used. Furthermore, the phosphor emission can self-quench at relatively low dopant concentrations, limiting the overall absorption efficiency. Finally, the low energy levels from which MWIR emission occurs have very long (>1 millisecond) emission lifetimes, so that both branching ratios and quantum yields of these transitions tend to be very low.

Quantum dots may be suitable as the additive for a CAS CCID application of photo-emissive film. Quantum dots can be excited over a range of wavelengths, up to their exciton wavelength, and emit at slightly longer wavelength than the exciton wavelength. The exciton wavelength depends on the size and composition of the quantum dot. Therefore, a quantum dot with an exciton wavelength of 4 μm will absorb at all wavelengths below 4 μm, including 1.06 and 1.57 μm, but it emits only at a wavelength slightly longer than 4 μm. Quantum dots of PbSe and HgTe have been synthesized with MWIR excitons. MWIR PbSe quantum dots have been shown to have quantum yield as high as 0.5%, although MWIR HgTe quantum dots have much lower quantum yield, about 0.01%. Quantum dots have very short emission lifetimes, on the order of nanoseconds. Therefore, in this example, quantum dots may be the emitter.

A plurality of lenslets may be formed of an array of infrared transmitting microspheres, herein referred to as “lenslets.” Two designs are possible; in one case the lenslets is fully embedded in a luminescent layer, and the lenslets have a higher refractive index than the luminescent layer. In a second design, the lenslets are partially embedded in the luminescent layer, where the depth of embedding is at least 5% of the average diameter of the plurality of lenslets. Both the lenslets and luminescent layer may be formed from one or more materials including an IR-transparent polymer, a crystalline material, or from an IR-transparent glass. The luminescent layer may be transparent at one or both of 1.06 μm and 1.57 μm wavelengths, and at the quantum dot emission wavelength, for example 4 μm. Examples of suitable glasses include ZrF₄ based glasses including ZBLAN and sulfide glasses including Gallium-Lathanum-Sulfide glass. An example of a suitable luminescent layer material includes poly(methyl methacrylate) (PMMA), which has some transparent windows in the MWIR wavelength range.

In this example, a photo-emissive film was fabricated from a PMMA film, a plurality of ZBLAN lenslets, and PbSe quantum dots with emission wavelength λ₂ of 3.7 μm.

PbSe quantum dots (QDs) with cubic form factor and 17 nm edge length were dried from a tetrachloroethylene solution. Then, 37.3 mg of dried QDs were re-suspended in 2.25 g anisole. Separately, an anisole/PMMA solution was prepared at 41.7 weight %. Further, 5.74 g of the anisole/PMMA solution was mixed with the QD/anisole solution.

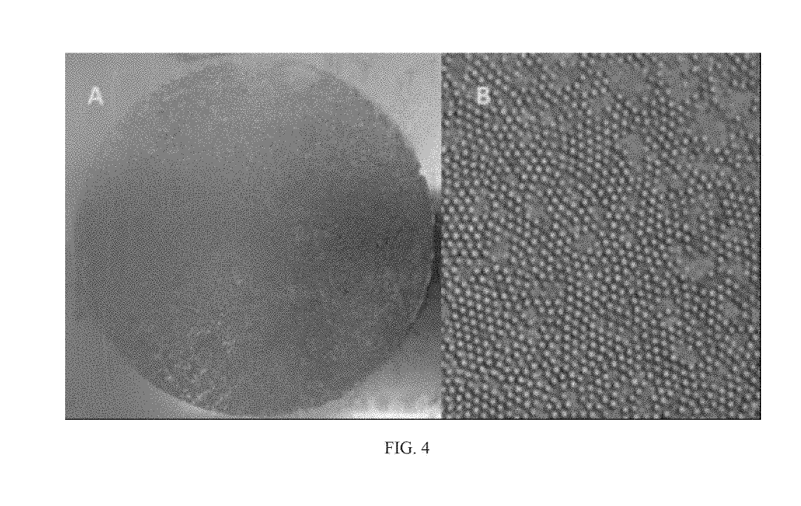

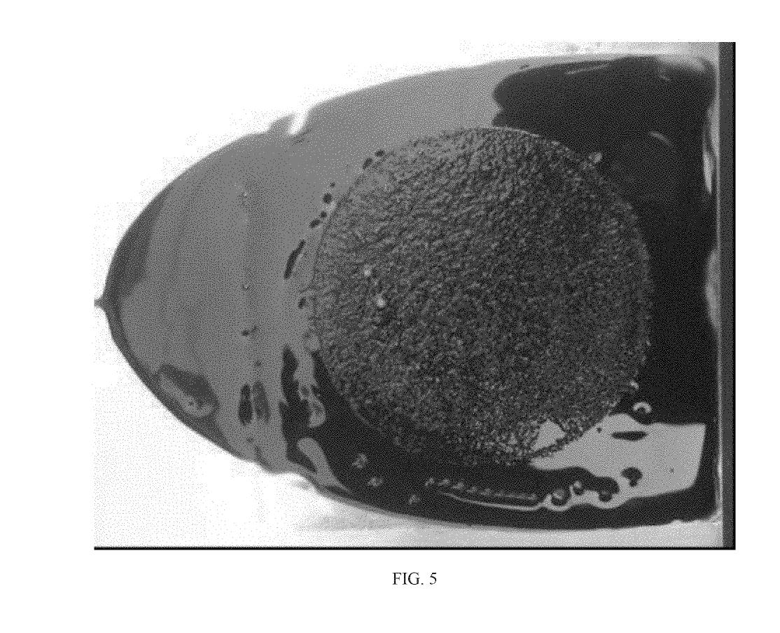

A piece of PTFE film of approximately 2 mil thickness was placed on a polished aluminum substrate to serve as a release layer. A circular form 2 inches in diameter was clamped to the substrate. Approximately 1 g of ZBLAN lenslets with median diameter 179 μm were poured into the form. A small amount of acetone was used to prevent clumping. The form was gently tipped and rotated until the lenslets formed a self-assembled, single-layer, close-packed array, which can be seen in FIG. 4. The acetone was then allowed to evaporate.

Surprisingly, the evaporating acetone did not disrupt the order of the lenslet array, whereas it was observed to disrupt the order of other arrays formed from soda-lime glass lenslets. While not wishing to be bound by theory, it appears that the high density of the ZBLAN glass lenslets (4.5 g/cm³) gives them sufficient inertia that the evaporating solvent front does not disturb their order.

A solution of PMMA dissolved at 2 weight % in trichloroethylene was added dropwise to the edge of the array. Each drop of solution was allowed to wick into the array before another drop was added. When the entire array had been wetted, the array was allowed to dry for about 1 hour. When the form was removed, the lenslet array was fixed in place by a thin layer of polymer, estimated less than about 10 μm thick.

The aluminum plate holding the array was placed on a drawdown table. A 40 mil drawdown bar was used. Approximately 3 mL of QD/PMMA/anisole solution was placed on the drawdown table and a film was cast across the lenslet array. The photo-emissive film was allowed to dry for about 24 hours. Faster drying solvents such as acetone and trichloroethylene were also tried, but left bubbles in the film. The photo-emissive film thickness was measured to be about 400 μm including the lenslet thickness.

The photo-emissive film was peeled from the substrate, flipped to the reverse side, and etched using a 50/50 mixture of isopropyl alcohol and anisole. The solution was applied with a small foam roller and removed by dabbing with a Kimwipe tissue. The film was periodically inspected under a microscope to monitor the degree to which the lenslets had become exposed. When the full diameter of most of the plurality of lenslets was clearly visible, etching was stopped. If a lenslet is embedded in a polymer film with matching refractive index, it is substantially invisible. When the full diameter of a lenslet is visible, it is interpreted that the depth of embedding has been reduced to half the diameter of the sphere.

A second film was also prepared in a similar manner, but without ZBLAN lenslets. This lenslet-free film was used as a control.

The two films were separately placed in the field of view of an InSb camera equipped with a 3 μm to 5 μm bandpass filter. The films were illuminated by a 1.064 μm Nd:YAG laser with the following parameters: pulse width 4 ns, pulse energy 10 mJ, divergence full angle 1.1 mrad. The laser was steered by a series of four high-power-tolerant mirrors. The last mirror was placed next to the camera lens, so that the laser axis would approximately coincide with the camera viewing axis—the ideal configuration for observing photo-emission in the direction of the light source. Using a beamsplitter, a green laser pointer was overlapped with the 1.064 μm beam to facilitate alignment of the laser onto the target. The apparatus was placed on a rolling table and the distance from camera to target was varied from 2 meters to 20 meters.

The laser was configured to fire two pulses in sequence, separated by about 25 μs. Emission from the back end of the laser crystal was captured by a photodiode, which served as a first trigger signal. The first trigger signal was passed to a delay generator, which generated a second trigger signal, delayed between 20 μs and 35 μs relative to the first trigger signal. The second trigger signal was passed to the InSb camera. The InSb camera began image acquisition less than 200 ns after receipt of the second trigger signal.

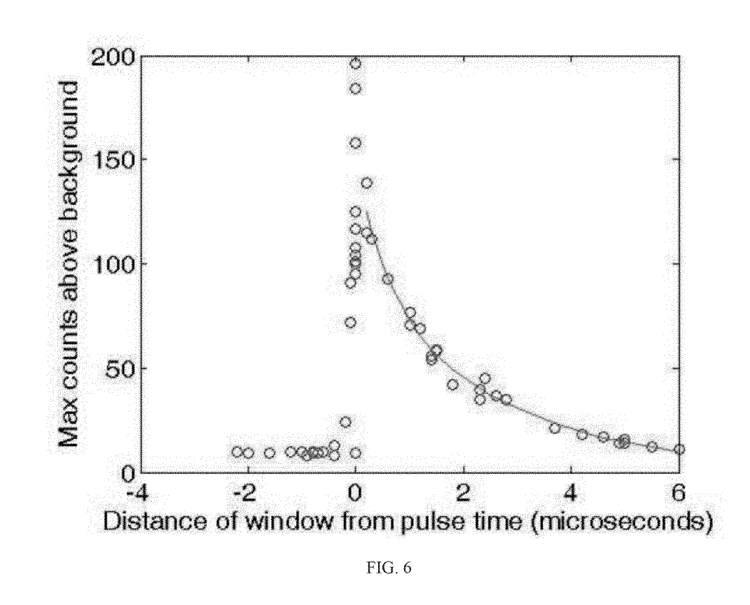

In one experiment, an IRC806 f/2.3 camera equipped with a 25 mm f/2.3 lens was used. In these experiments the distance from camera to target was about 24 inches and the laser was diverged to approximately 7 mrad. In other experiments, a FLIR A6700sc f/2.3 camera with a 100 mm f/2.3 lens was used. The laser was used at minimum divergence angle of 1.1 mrad. The second laser flash was timed to be before, during, or after the camera integration window (1 μs long). The decay lifetime of PbSe quantum dot fluorescence is known from literature studies to be on the order of 3 μs. In experiments where the second laser flash came after the camera integration window, the camera could not detect any fluorescence from the first laser flash after 25 μs or any thermal emission. In experiments where the second laser flash came during the camera integration window, high emission values were observed. In experiments where the second laser flash came before the camera integration window, the emission values decayed according to the delay in opening the camera shutter after the laser flash. The intensities were plotted against time and found to fit a bi-exponential decay, seen in FIG. 6, with decay constants of 0.5 μs and 3.0 μs. This confirmed that a shutter time of at least 3 μs is desirable to record fluorescence.

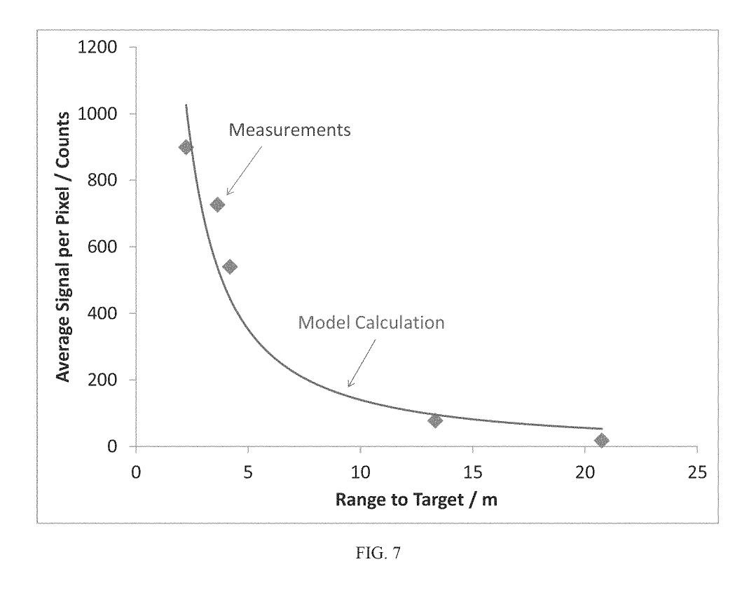

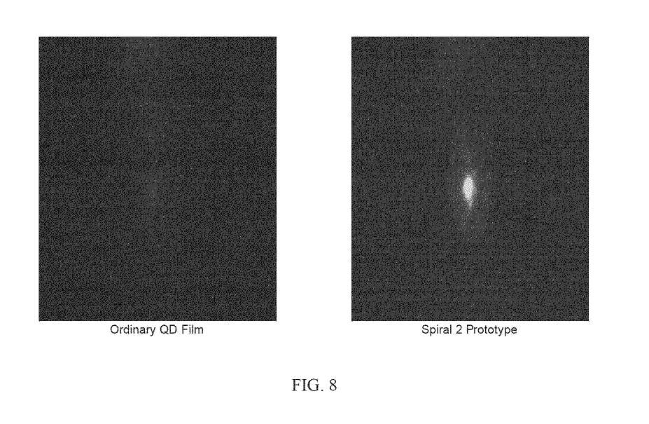

A plot of mid-infrared fluorescence values versus the camera-to-target distance is shown in FIG. 7. The falloff with distance is reproduced accurately by a mathematical model. The photo-emissive film was compared to the lenslet-free film containing only quantum dots. The photo-emissive film had a peak emission 60 times higher than the peak emission of the reference film. A visual comparison of brightness between the two films is shown in FIG. 8.

### Example 2

### Comparison of Embedded and Exposed Lens Designs

A near-infrared version of the photo-emissive film suitable for use in ground-ground Combat ID may be designed using ordinary glass lenslets according to any of the above embodiments or using a plurality of BaTiO₃ lenslets with the embedded design shown in FIG. 3. Both designs were prepared using LD800 laser dye, with emission beyond 700 nm. A 660 nm CW diode laser was used for excitation. Fluorescence was recorded with a Pike F-032B monochrome camera using a 700 nm longpass filter to block scattered laser light.

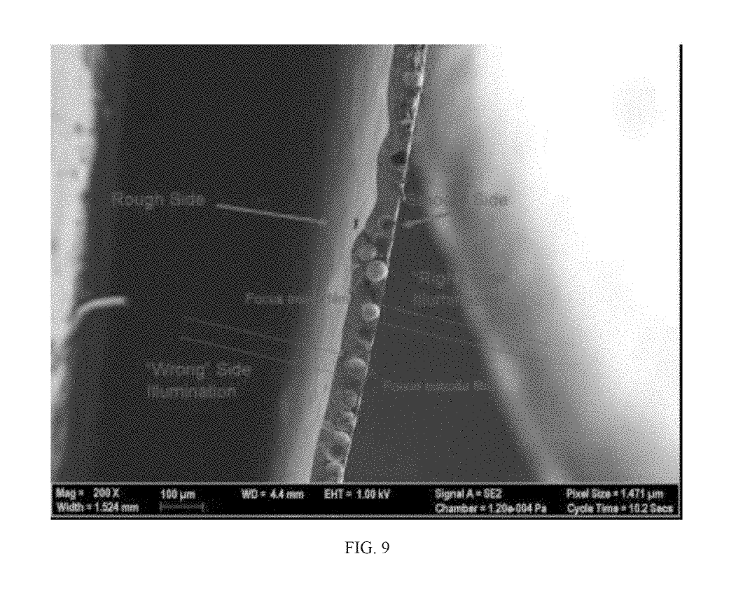

To prepare the embedded design film, 50 μm diameter BaTiO₃ lenslets were mixed into a solution of PMMA/anisole and cast as a film. The dense lenslets settled to the bottom of the film as it was drying, forming a reasonably well packed monolayer at one side of the film. A micrograph of a cross-section of this film is shown in FIG. 9.

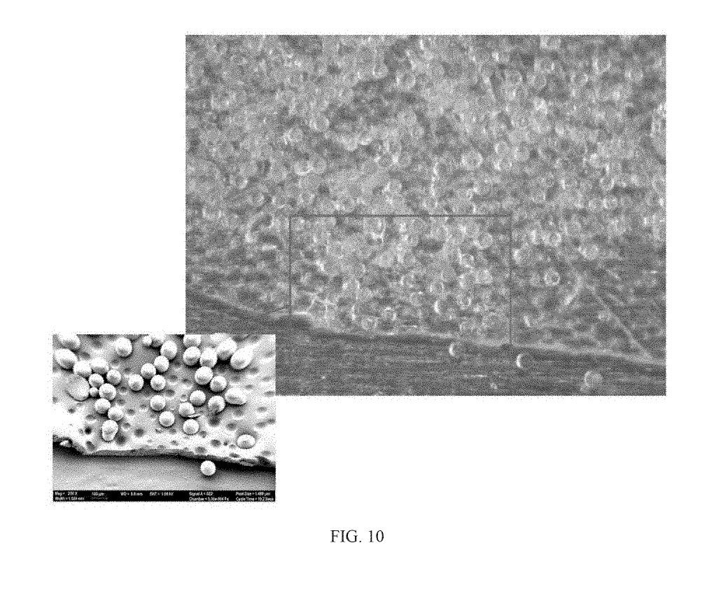

A first PMMA film of about 40 μm thickness was cast onto an aluminum plate. The film was rubbed with a nitrile glove to create static charge, and 100 μm diameter soda-lime glass lenslets were deposited on the film. The plate was turned on edge and tapped to remove excess lenslets, while the remaining lenslets formed a monolayer, although it was not close-packed. The photo-emissive film and plate were placed between two silicone pads, with the bottom pad heated to 210° F., and fed into the nip of a CODA hand-cranked roll press. The photo-emissive film was rolled back and forth multiple times to promote embedding of the lenslets into the PMMA and then quickly removed from the heating pads to allow for cooling. The lenslet/PMMA photo-emissive film was then removed from the underlying aluminum substrate with a razor and a second PMMA film with a thickness of about 40 μm laminated onto the film's backside to produce the desired thickness of the luminescent layer. Both a light microscope and SEM image of a section of this film are shown in FIG. 10.

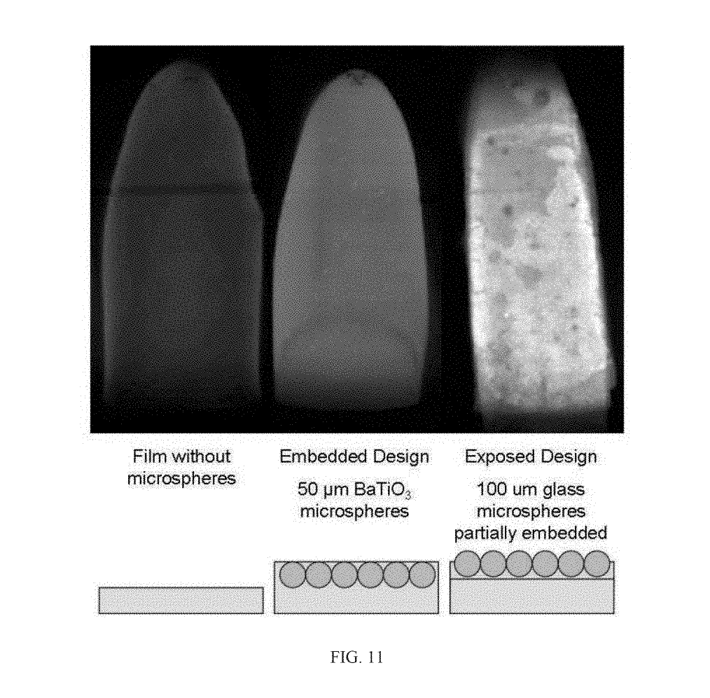

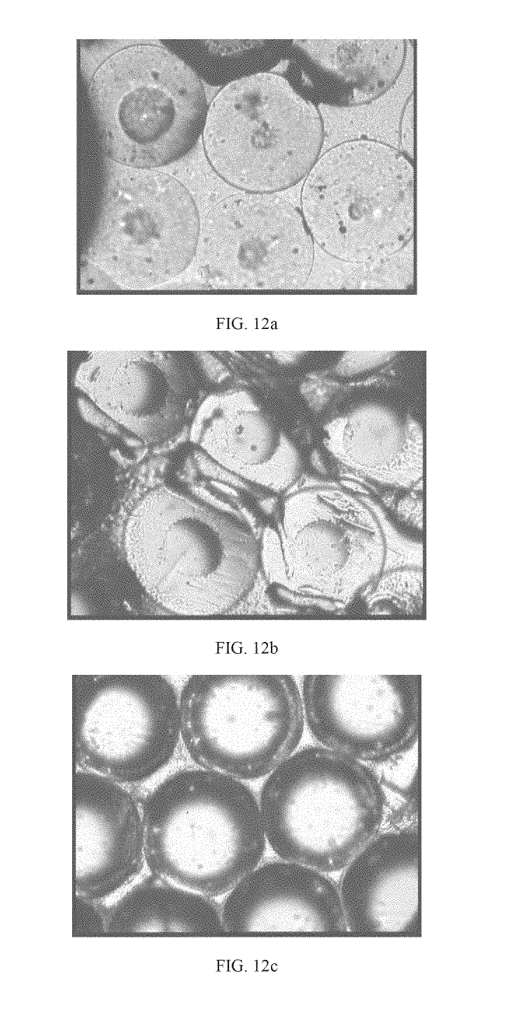

A comparison of fluorescence between a film without lenslets, an embedded-design photo-emissive film according to FIG. 3, and a photo-emissive film according to FIG. 2 is shown in FIG. 11. The superiority of the photo-emissive film according to FIG. 2 is clear from this image as it produced 10 times brighter fluorescence compared to the film without the lenslets.

### Example 3

### Alternative Method of Fabrication

The methods of Example 1 and Example 2 are based on thin films. In the present example we describe an alternate method of casting. This example additionally teaches the use of a thicker photo-emissive film of about 3 mm, which provides stability against curling and potentially provides improved optical performance. A casting form was produced by cutting a hole in a thick silicone sheet, for example a 25 mm diameter circular hole in a 3 mm silicone sheet. The silicone sheet is placed on a low surface energy, rigid, smooth substrate. For example, a steel test panel was used as a substrate. The silicone sheet should adhere to the substrate without additional adhesive.

A weighed amount of glass lenslets with refractive index near 1.5 was poured into the casting form. The target weight of the glass lenslets was determined by the following formula:

$${m}_{spheres} = \frac{{A}_{form}}{{A}_{sphere}} \times {V}_{sphere} \times {ρ}_{sphere} \times 0.91$$

where mₛₚₕₑᵣₑₛ is the mass of lenslets to be weighed out; A_{form} is the area of the casting form; Aₛₚₕₑᵣₑ is the cross sectional area of a lenslet; Vₛₚₕₑᵣₑ is the volume of a lenslet; ρₛₚₕₑᵣₑ is the density of the lenslet material (e.g., about 2.5 g/cm³ for soda lime glass); and the factor 0.91 is the approximate packing fraction for ideal circles in a plane. This gives only an approximate value for the mass of lenslets to be used because (a) the lenslet size distribution is not infinitely monodisperse; (b) the lenslets may adhere to the weighing medium and may not all be transferred to the substrate; or (c) the lenslets may preferentially pile up at the edges of the form.

The plurality of lenslets may self-assemble into a monolayer. This can be accomplished by one or more of the following methods. (1) Addition of a volatile solvent that can neutralize charge that may cause the lenslets to clump. The monolayer can be formed by vibrating or swirling the lenslets within the form. (2) Pressing with a smooth press tool that fills the form. A glass optical window, a polished metal disc, or a plastic disc cast using the same form are examples of press tools that may be used. One skilled in the art will recognize that if the form is not circular in shape, a press tool of appropriate shape would be used. (3) Vibrational energy may be used to anneal the lenslets into a monolayer, for example by touching the substrate or form with an ultrasonic excitation. (4) Some combination of these methods may be required; for example method (1) may be needed to neutralize charge, but the evaporating solvent front may push lenslets out of the monolayer arrangement, especially if the solvent does not wet the substrate well. Then, a second method such as (2) or (3) can be used to restore the monolayer order.

In forming the monolayer, formation of additional layers should be avoided as these will cause unnecessary internal scattering as well as voids in the luminophore distribution, both of which reduce retro-emissive performance.

A thin fixative layer of polymer, for example a solution of 1% PMMA in CH₂Cl₂, was then applied slowly (e.g., dropwise via syringe) and each drop was allowed to wick throughout the sphere layer. Only enough polymer to bind together the lenslets was applied.

After the fixative layer was applied, an etchable, clear potting compound was used to mold a thick film over the lenslets. For example, a commercial two-part acrylic casting resin (such as is sold for microscopy or for craft applications) may be used. A luminophore (dye, quantum dot, or nanophosphor) is mixed into the resin. For example, Rhodamine 6G was mixed into a commercial two-part acrylic resin at a concentration of about 10 millimolar. One skilled in the art will understand that the luminophore concentration determines the depth of penetration of the excitation light into the photo-emissive film and therefore the distribution of luminescence emission. Therefore the luminophore concentration may be optimized either by optical modeling or by experiment to give best retro-emissive performance. One skilled in the art will further understand that luminescence from relatively deep in the film, between 0 to 3 lenslet diameters, may be captured and focused by the lenslets to a lesser or greater extent. Therefore a thicker film will improve performance, but beyond a certain thickness no additional performance improvement will be realized. Therefore the photo-emissive film thickness may also be optimized to give a good balance between retro-emissive performance and non-optical film properties such as strength and flexibility.

### Example 4

### Demonstration of Source-Directed Emission

Photo-emissive films fabricated according to the designs described herein and according to the means described herein, or other suitable means, have the property that the emission intensity in the direction of the excitation light source is greater than would be predicted for an isotropically emitting film (i.e., a film that emits substantially equally in all directions).

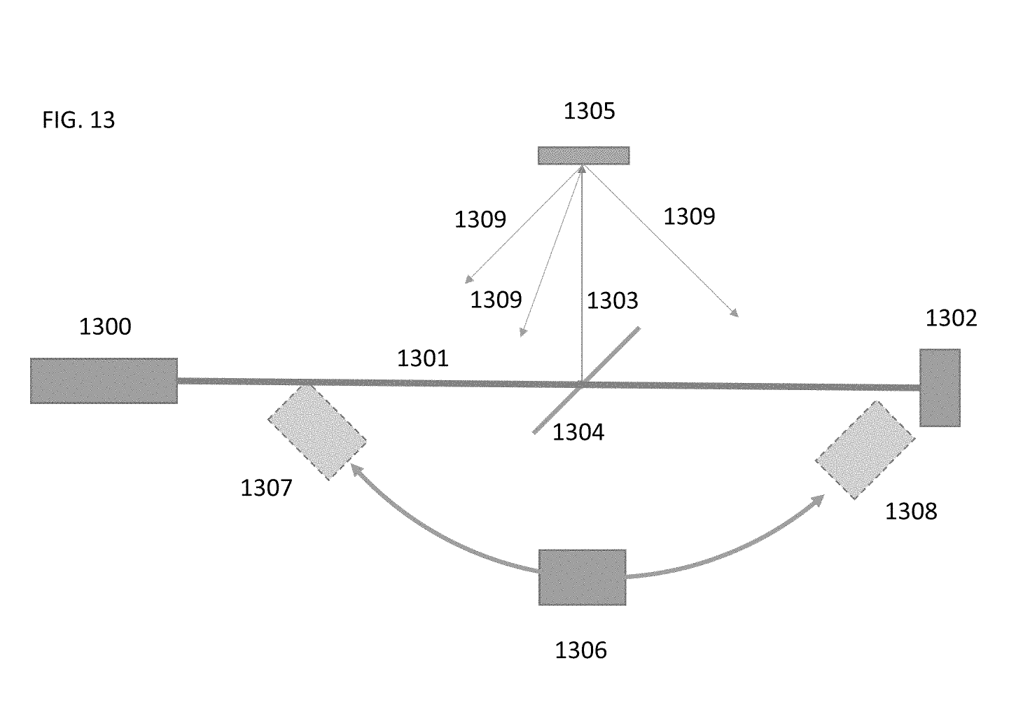

FIG. 13 shows an optical measurement apparatus designed to measure the emission intensity from a photo-emissive film when the film is illuminated at a fixed angle and the emission is measured over a range of angles. In the apparatus, a laser 1200 produces a beam 1201 that passes through a glass plate 1204 and that impinges on a beam stop 1202 which absorbs the portion of the beam that passes through the glass plate. A portion 1203 of the laser beam 1201 reflects from the glass plate 1204 toward a photo-emissive film 1205. Emission 1209 from the photo-emissive film emanates in many directions. A detector 1206 is disposed to capture part of the emission. The detector is fixed to a rotating mount (not shown) so that it can be positioned through different angles ranging from position 1207 to position 1208 and capture a different portion of the emission at each angle. The detector mount is designed so that a fixed distance from photo-emissive film to detector is maintained at each angle.

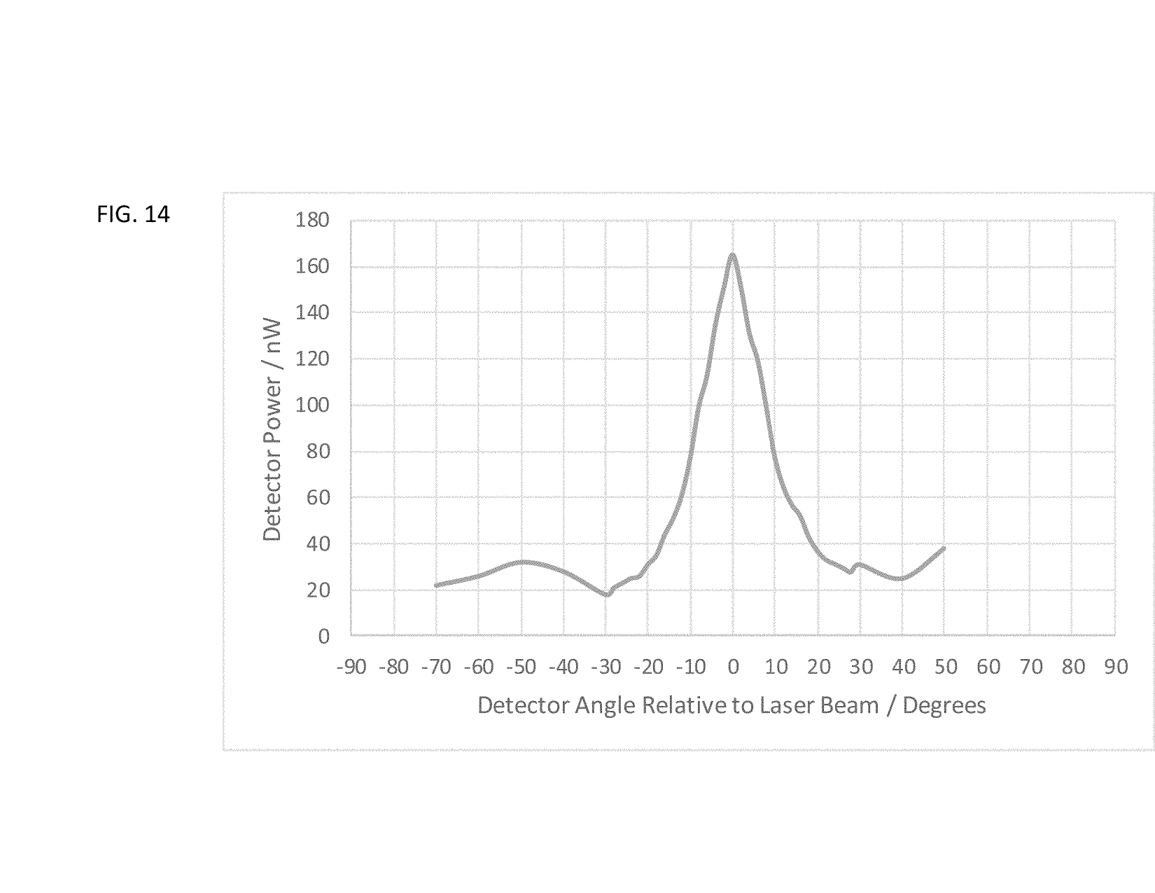

FIG. 14 shows a plot of emission intensity as a function of angle obtained from the apparatus of FIG. 13 using a photo-emissive film according to an embodiment. The figure shows that the photoluminescence from the film is sharply peaked at zero degrees relative to the laser incidence angle.

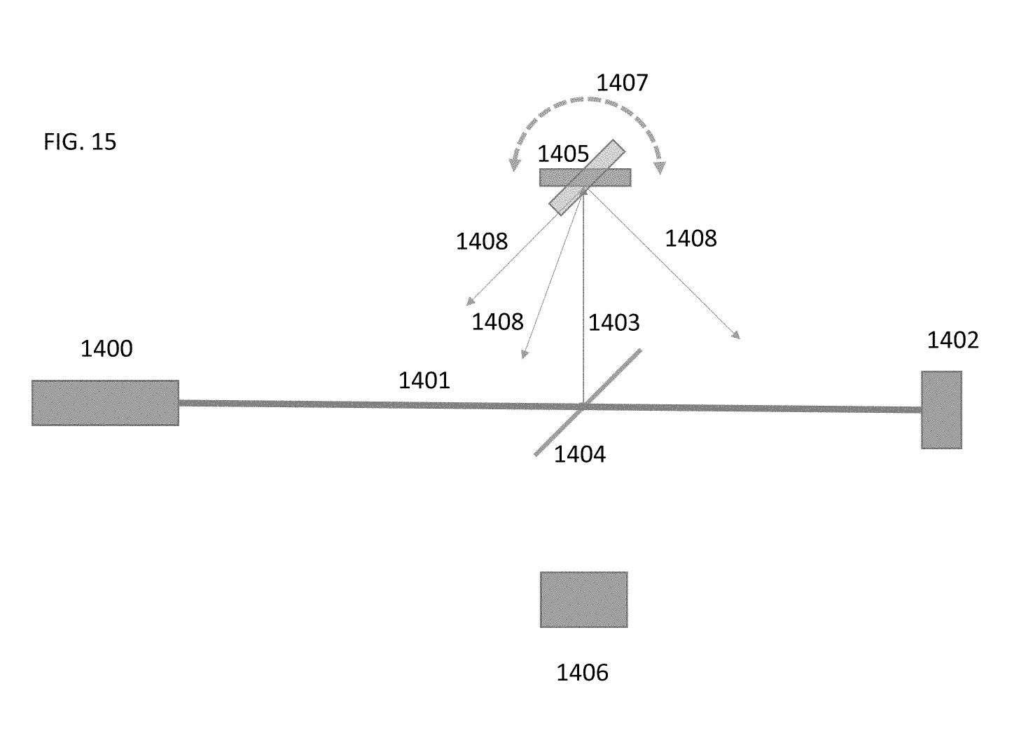

FIG. 15 shows an apparatus that can be used to measure the emission intensity from a photo-emissive film when the film is illuminated over a range of angles and the emission is measured at a fixed angle. In the apparatus, a laser 1400 produces a beam 1401 that passes through a glass plate 1404 and that impinges on a beam stop 1402 which absorbs the portion of the beam that passes through the glass plate. A portion 1403 of the laser beam 1401 reflects from the glass plate 1404 toward a photo-emissive film 1405. The photo-emissive film is disposed on a rotating mount so that its angle relative to the laser angle can be varied through a range of angles 1407. The range of angles is such that the photo-emissive film can be illuminated from both the sphere side and the non-sphere side. Emission 1408 from the photo-emissive film emanates in many directions. A camera 1406 is disposed to image the part of the emission that returns toward the light source.

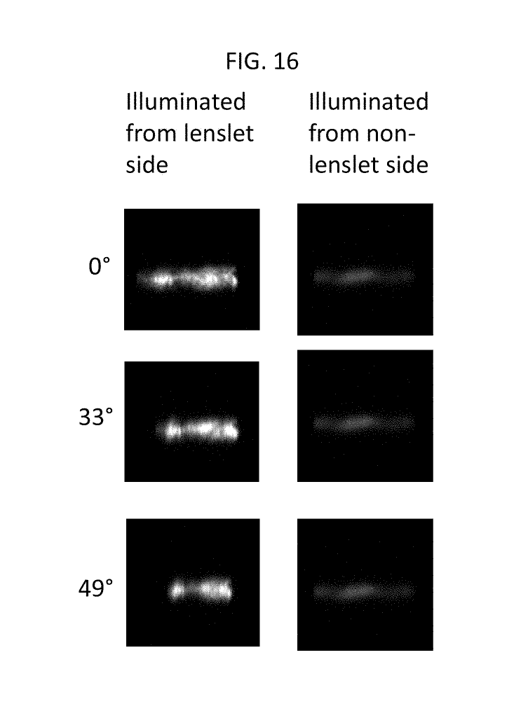

FIG. 16 shows the results of an experiment with the apparatus of FIG. 15. In FIG. 16, a column of images 1501 is shown wherein the images result from illumination of the photo-emissive film from angles of 0°, 33°, and 49°. The photoluminescence is shown to be bright in each case as long as the photo-emissive film is illuminated from the lenslet side as illustrated in FIG. 2. A column of images 1502 is shown wherein the images result from illumination of the photo-emissive film from angles of 0°, 33°, and 49°. The images in this column represent the result of illuminating the photo-emissive film from the non-lenslet side, in the opposite direction that is illustrated in FIG. 2. In this case, the focal point of the lenslets is outside the film and no enhancement of the photoluminescence occurs. In each of these images the photoluminescence is less bright than the corresponding image in column 1501.

The disclosed embodiments may be embodied in many different forms, and this disclosure should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms “first,” “second,” “third,” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A photo-emissive film comprising:
a luminescent layer that is substantially transparent to at least one excitation wavelength λ₁ and at least one emission wavelength λ₂, the luminescent layer having a first refractive index n₁, and
a plurality of lenslets at least partially embedded in the luminescent layer in a substantially single plane, the plurality of lenslets having a second refractive index n₂, wherein
the focal point of the plurality of lenslets is external to the plurality of lenslets and within the luminescent layer; and
the luminescent layer comprises a polymer, a crystalline material, a glass, or mixtures thereof.

2. The photo-emissive film of claim 1, wherein
the at least one excitation wavelength λ₁ is between about 0.7 μm and 1.7 μm; and
the at least one emission wavelength λ₂ is between about 3.6 μm and 4.5 μm.

3. The photo-emissive film of claim 1, wherein the photo-emissive film emits at least one emission wavelength λ₂ in the direction of a light source, the magnitude of the at least one emission wavelength λ₂ emitted in the direction of the light source being greater than what would be predicted for isotropic emission over π steradians.

4. The photo-emissive film of claim 1, wherein the photo-emissive film has a total width of between about 0.01 mm and 3.0 mm.

5. The photo-emissive film of claim 1, wherein the plurality of lenslets has an average focal length between about 15 μm and 2,000 μm.

6. The photo-emissive film of claim 5, wherein the luminescent layer has a width that is at least about 1.5 times the average focal length of the plurality of lenslets.

7. The photo-emissive film of claim 1, wherein the photo-emissive film further comprises a photo-emissive additive that absorbs the at least one excitation wavelength λ₁ and emits the at least one emission wavelength λ₂.

8. The photo-emissive film of claim 7, wherein the photo-emissive additive comprises quantum dots, fluorescent dyes, phosphors, or combinations thereof.

9. The photo-emissive film of claim 7, wherein the photo-emissive additive comprises an absorbing material that emits infrared radiation by a thermal emission process.

10. The photo-emissive film of claim 9, wherein the photo-emissive additive is carbon black.

11. The photo-emissive film of claim 1, wherein the plurality of lenslets comprise glass, crystalline materials, polymeric materials, or combinations thereof.

12. The photo-emissive film of claim 1, wherein the plurality of lenslets has a transmission fraction t₁ at the at least one excitation wavelength λ₁ and a transmission fraction t₂ at the at least one emission wavelength λ₂, such that the product t₁t₂ is at least 0.3%, preferably at least 0.5%, and more preferably at least 0.9%.

13. The photo-emissive film of claim 1, wherein
the plurality of lenslets is substantially spherical and is embedded in the luminescent layer at a depth of between about 40% and 95% of the average diameter of the plurality of lenslets;
a non-embedded portion of the plurality of lenslets is exposed to an ambient medium with refractive index n₁ of about 1; and
the plurality of lenslets has a refractive index n₂ of between about 1.3 and 2.

14. The photo-emissive film of claim 1, wherein
the plurality of lenslets is substantially spherical and is embedded in the luminescent layer at a depth of greater than about 95% of the average diameter of the plurality of lenslets;
the plurality of lenslets has a refractive index n₂; and
the luminescent layer has a refractive index n₃, such that the ratio of n₂ to n₃ is between about 1.3 and 2.

15. The photo-emissive film of claim 1, wherein the plurality of lenslets is aspheric and are disposed with a common orientation so that the optical axis of the plurality of lenslets is substantially perpendicular to a face of the photo-emissive film.

16. The photo-emissive film of claim 1, wherein the plurality of lenslets is arranged in the form of a monolithic film.

17. The photo-emissive film of claim 1, wherein the plurality of lenslets has an areal fill factor of at least 0.5, preferably greater than 0.8, and more preferably greater than 0.9.

18. The photo-emissive film of claim 1, wherein the plurality of lenslets has an average subtended half-angle greater than 25°.

19. The photo-emissive film of claim 1, wherein the photo-emissive film further comprises a coating selected from a protective film, printed film, optical filter layer, structural layer, adhesive layer, and combinations thereof.

20. The photo-emissive film of claim 1, wherein the polymer is poly(methyl methacrylate).

21. The photo-emissive film of claim 1, wherein the polymer comprises a fluoropolymer.

22. The photo-emissive film of claim 21, wherein the fluoropolymer is substantially free from a functional amount of C—H, O—H, N—H, or S—H bonds.
